(19) United States
(12) Patent Application Publication
(10) Pub. No.: US 2005/0068679 A1
(43) Pub. Date: Mar. 31, 2005

(54) Magnetic storage medium and method for making same

(76) Inventor: Ga-Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/900,683

(22) Filed: Jul. 27, 2004

(30) Foreign Application Priority Data
Sep. 26, 2003 (TW) 92126626

(51) Int. Cl. G11B 5/74; G11B 23/00

(52) U.S. Cl. 360/131

(57) ABSTRACT

A magnetic storage medium (10) includes a base having an array of carbon nanotubes (12), and a magnetic material represented by the formula CoCrXYZ disposed therein. X is selected from the group consisting of the elements tantalum, niobium and zirconium, Y is selected from the group consisting of the elements platinum, palladium and gold, and Z is selected from the group consisting of the elements boron, phosphorus, nitrogen and oxygen. Due to the limitation of the carbon nanotubes, the magnetic material forms a number of rod-shaped bodies (14). Each body shows magnetic anisotropy in perpendicular directions, and an intrinsic coercive force of the magnetic material in each body along an axial direction of the rod approaches as high as 8,000˜20,000 Oe. Therefore the superparamagnetic phenomenon caused by changes in temperature is prevented, and an areal information storage density approaches as high as 6.45×10¹³ bits per square inch.

### BACKGROUND OF THE INVENTION

1. Field of the Invention

The present invention relates to magnetic storage mediums and methods for making them, and more particularly to a magnetic storage medium incorporating carbon nanotubes with high bit storage density.

2. Description of Related Art

With the rapid development of information technology, it is critical to fabricate magnetic storage mediums with very high information bit storage densities. Generally a magnetic storage medium is formed of magnetic particles, and when the size of the magnetic particles is reduced, the information bit storage density of the magnetic storage medium is increased. However, the smaller the size of the magnetic particles, the less stable the magnetic particles are. When the magnetic particles have a very small size, they can be affected by changes in temperature and exhibit the superparamagnetic phenomenon. Therefore, a magnetic storage medium with a high information bit storage density must have high magnetization intensities and a strong intrinsic coercive force. In order to increase an areal information bit storage density and prevent the superparamagnetic phenomenon, it is desired to find a way to reduce the sizes of the magnetic particles while at the same time increasing the intrinsic coercive force of the magnetic particles.

The limitations of conventional lithographic and self-assembly media fabrication techniques for dimensions below 0.1 microns (100 nanometers) are well known. Optical lithography with a light source in the deep ultra-violet (“DUV”) spectrum is widely expected to provide media fabrication for sizes down to 0.05 microns (50 nanometers), but not for smaller sizes. DUV optical lithography is currently anticipated to be extended to lateral dimensions of 50 nanometers, but such extension is not yet certain and may be expensive. At dimensions below ˜50 nanometers, X-ray lithography and Extreme UV lithography are being considered. However, both these techniques require enormous capital investments, both for the radiation sources and the supporting optical systems.

A method for self-assembly of 40-70 nanometer sized particles made of latex or other polymers is described in an article entitled “A Simple Method for the Production of a Two-dimensional, Ordered Array of Small Latex Particles” by Micheletto et al. in Langmuir, 1995, v.-11, p. 333. Further, formation of ordered arrays of 5-10 nanometer sized semiconductor particles is described in an article entitled “Self-organization of CdSe Nanocystallites into Three-dimensional Quantum Dot Superlattices” by Murray et al. in Science, 1995, v. 270, p.-1335.

China Pat. No. CN99110405.6, issued on Jun. 4, 2003 and assigned to the IBM Company, discloses a method for fabricating a magnetic storage medium formed of nanoparticles. The magnetic storage medium is formed from a layer of substantially uniformly spaced-apart magnetic nanoparticles of substantially uniform diameter disposed upon a surface of a substrate, with a coating, preferably of abrasion-resistant material, applied to adhere the nanoparticles to the substrate and to maintain their substantially uniform spaced-apart relationship. The nanoparticles each have a diameter less than 50 nanometers, and are formed from a magnetic material selected from the group consisting of the elements cobalt (Co), iron (Fe), manganese (Mn), samarium (Sm), neodymium (Nd), praseodymium (Pr), platinum (Pt), gadolinium (Gd), an intermetallic compound of said elements, a binary alloy of said elements, a ternary alloy of said elements, an oxide of Fe further comprising at least of one of said elements other than Fe, barium ferrite, and strontium ferrite. The magnetic storage medium has an areal bit density exceeding 100 gigabits per square inch, and even approaching as high as 10¹² bits (1 Tbit) per square inch.

However, the magnetic storage medium is formed from magnetic nanoparticles by self-assembly. The magnetic nanoparticles may not have uniform dimensions. In addition, it is believed that if the dimensions of the magnetic nanoparticles were to be even further reduced, this would result in the superparamagnetic phenomenon. That is, the areal information bit storage density of the magnetic storage medium is inherently limited by the nature of its structure.

### SUMMARY OF THE INVENTION

Accordingly, an object of the present invention is to provide a magnetic storage medium which is formed from highly uniform nanoparticles.

Another object of the present invention is to provide a magnetic storage medium which has a high areal information bit storage density.

A further object of the present invention is to provide a method for making the above-described magnetic storage medium.

In order to achieve the objects set forth, a magnetic storage medium in accordance with the present invention comprises a base having an array of carbon nanotubes, and a magnetic material represented by the formula CoCrXYZ disposed in the carbon nanotubes. X is selected from the group consisting of the elements tantalum (Ta), niobium (Nb) and zirconium (Zr), Y is selected from the group consisting of the elements platinum (Pt), palladium (Pd) and gold (Au), and Z is selected from the group consisting of the elements boron (B), phosphorus (P), nitrogen (N) and oxygen (O). Each of the carbon nanotubes has a diameter in the range from 1 to 5 nanometers, and a height in the range from 2.5 to 7.5 nanometers. A distance between adjacent carbon nanotubes is in the range from 2 to 10 nanometers.

A method for fabricating the above described magnetic storage medium in accordance with the present invention comprises the following steps: providing a base having an array of carbon nanotubes, and disposing a magnetic material represented by the formula CoCrXYZ in the carbon nanotubes. X is selected from the group consisting of the elements tantalum (Ta), niobium (Nb) and zirconium (Zr), Y is selected from the group consisting of the elements platinum (Pt), palladium (Pd) and gold (Au), and Z is selected from the group consisting of the elements boron (B), phosphorus (P), nitrogen (N) and oxygen (O). The magnetic material has 60˜90 mol % of Co, 5˜20 mol % of Cr, 2˜5 mol % of X, 5˜15 mol % of Y and 1˜15 mol % of Z. Each of the carbon nanotubes has a diameter in the range from 1 to 5 nanometers, and a height in the range from 2.5 to 7.5 nanometers. A distance between adjacent carbon nanotubes is in the range from 2 to 10 nanometers.

Due to the limitation of the shape of the carbon nanotubes, the magnetic material of the present magnetic storage medium forms a plurality of rod-shaped bodies, with each rod-shaped body having a diameter in the range from 1 to 5 nanometers. In addition, each rod-shaped body shows magnetic anisotropy in perpendicular directions, and an intrinsic coercive force of the magnetic material in each rod-shaped body along an axial direction of the rod approaches as high as 8,000˜20,000 Oe. Therefore the superparamagnetic phenomenon between small dimensional magnetic particles caused by changes in temperature is prevented, and an areal information storage density approaches as high as 6.45×10¹³ bits per square inch.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic, isometric view of a magnetic storage medium according to the present invention, comprising a magnetic material disposed in an array of carbon nanotubes; and

FIG. 2 is a top elevation of the magnetic storage medium of the present invention.

### DETAILED DESCRIPTION OF PREFERRED EMBODIMENTS OF THE INVENTION

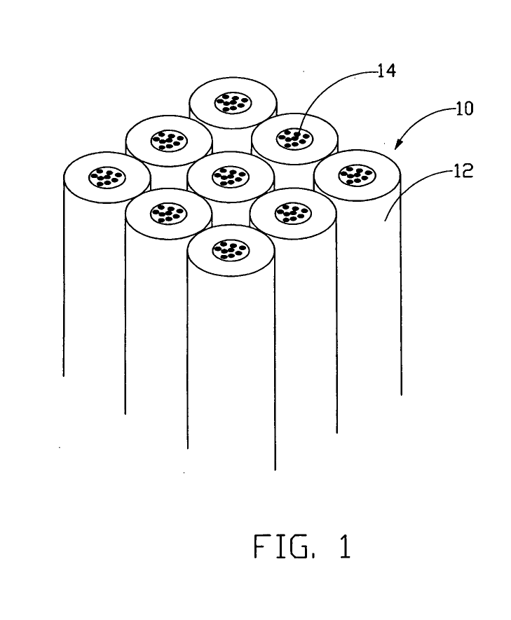

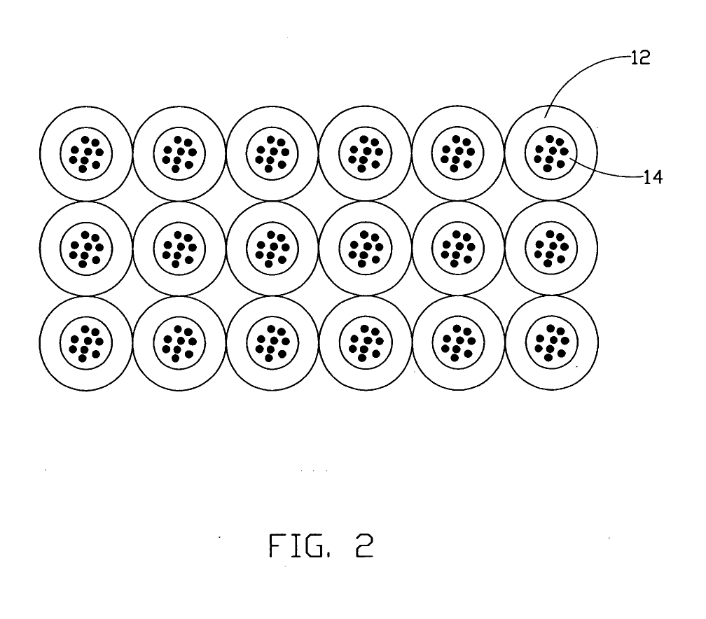

Referring to FIGS. 1 and 2, a magnetic storage medium 10 according to the present invention comprises a base having an array of carbon nanotubes 12, and a magnetic material represented by the formula CoCrXYZ disposed in the carbon nanotubes 12. X is selected from the group consisting of the elements tantalum (Ta), niobium (Nb) and zirconium (Zr), Y is selected from the group consisting of the elements platinum (Pt), palladium (Pd) and gold (Au), and Z is selected from the group consisting of the elements boron (B), phosphorus (P), nitrogen (N) and oxygen (O).

The array of carbon nanotubes 12 are formed by thermal chemical vapor deposition or plasma enhanced chemical vapor deposition. Generally, the chemical vapor deposition method for forming the array of carbon nanotubes 12 comprises the following steps: introducing a carbon source gas such as methane, ethane, etc into a reaction room; and then forming the array of the carbon nanotubes 12 in the presence of a catalyst after a period of time. The carbon nanotubes 12 are rod shaped, and have a uniform distribution. Each of the carbon nanotubes 12 has a diameter in the range from 1 to 5 nanometers, and a height in the range from 2.5 to 7.5 nanometers. Preferably, a distance between adjacent carbon nanotubes 12 is in the range from 2 to 10 nanometers. Thus, the carbon nanotubes 12 are not twisted and are independent from each other.

The magnetic material CoCrXYZ has 60˜90 mol % of Co, 5˜20 mol % of Cr, 2˜5 mol % of X, 5˜15 mol % of Y and 1˜15 mol % of Z. In the present invention, disposing the magnetic material CoCrXYZ in the carbon nanotubes 12 comprises the following steps: forming the magnetic material CoCrXYZ into a thin film; positioning the thin film of magnetic material CoCrXYZ so that it faces the carbon nanotubes 12; and bombarding the thin film of magnetic material CoCrXYZ employing argon plasma in order to dispose the magnetic material CoCrXYZ in the carbon nanotubes 12. Alternatively, spatter coating, ion-beam deposition, thermal spraying, physical vapor deposition, nanoprinting or ion implantation can be employed to dispose the magnetic material CoCrXYZ in the carbon nanotubes 12.

When the magnetic material CoCrXYZ has been disposed in the carbon nanotubes 12, hydrogen fluoride is applied to clean surfaces of the carbon nanotubes 12 and remove any surplus magnetic material CoCrXYZ formed on the surfaces of the carbon nanotubes 12. Due to the limitation of the shape of the carbon nanotubes 12, the magnetic material CoCrXYZ of the present magnetic storage medium 10 forms a plurality of rod-shaped bodies 14, with each rod-shaped body 14 having a diameter in the range from 1 to 5 nanometers. In addition, each rod-shaped body 14 shows magnetic anisotropy in perpendicular directions, and an intrinsic coercive force of the magnetic material CoCrXYZ in each rod-shaped body 14 along an axial direction of the rod approaches as high as 8,000˜20,000 Oe. Therefore the superparamagnetic phenomenon between small dimensional magnetic particles caused by changes in temperature is prevented, and an areal information storage density approaches as high as 6.45×10¹³ bits per square inch.

Preferably, each rod-shaped body 14 has a diameter in the range from 1 to 3 nanometers, and a distance between adjacent rod-shape bodies 14 is in the range from 2 to 5 nanometers. Assuming that there is one magnetic particle per bit of information, the magnetic storage medium 10 of the present invention has an areal storage density approaching as high as 6.45×10¹³ bits per square inch.

It is to be understood that the invention may be embodied in other forms without departing from the spirit thereof. Thus, the present examples and embodiments are to be considered in all respects as illustrative and not restrictive, and the invention is not to be limited to the details given herein.

1. A magnetic storage medium comprising:
a base of carbon nanotubes arranged in a regular array; and
a magnetic material disposed in the carbon nanotubes.

2. The magnetic storage medium in accordance with claim 1, wherein the magnetic material is represented by the formula CoCrXYZ, in which X is selected from the group consisting of the elements tantalum, niobium and zirconium, Y is selected from the group consisting of the elements platinum, palladium and gold, and Z is selected from the group consisting of the elements boron, phosphorus, nitrogen and oxygen.

3. The magnetic storage medium in accordance with claim 2, wherein the magnetic material CoCrXYZ has 60˜90 mol % of Co, 5˜20 mol % of Cr, 2˜5 mol % of X, 5˜15 mol % of Y and 1˜15 mol % of Z.

4. The magnetic storage medium in accordance with claim 1, wherein each of the carbon nanotubes has a diameter in the range from 1 to 5 nanometers.

5. The magnetic storage medium in accordance with claim 1, wherein each of the carbon nanotubes has a height in the range from 2.5 to 7.5 nanometers.

6. The magnetic storage medium in accordance with claim 1, wherein a distance between adjacent carbon nanotubes is in the range from 2 to 10 nanometers.

7. A method for making a magnetic storage medium, comprising:
providing a base of carbon nanotubes arranged in a regular array; and
disposing a magnetic material in the carbon nanotubes.

8. The method for making a magnetic storage medium in accordance with claim 7, wherein the magnetic material is represented by the formula CoCrXYZ, in which X is selected from the group consisting of the elements tantalum, niobium and zirconium, Y is selected from the group consisting of the elements platinum, palladium and gold, and Z is selected from the group consisting of the elements boron, phosphorus, nitrogen and oxygen.

9. The method for making a magnetic storage medium in accordance with claim 7, wherein disposing the magnetic material in the carbon nanotubes comprises the following steps: forming the magnetic material into a thin film, positioning the thin film of magnetic material so that it faces the carbon nanotubes, and bombarding the thin film of magnetic material employing argon plasma.

10. The method for making a magnetic storage medium in accordance with claim 7, wherein spatter coating, ion-beam deposition, thermal spraying, physical vapor deposition, nanoprinting or ion inplantation is employed to dispose the magnetic material in the carbon nanotubes.

11. The method for making a magnetic storage medium in accordance with claim 7, wherein each of the carbon nanotubes has a diameter in the range from 1 to 5 nanometers.

12. The method for making a magnetic storage medium in accordance with claim 7, wherein each of the carbon nanotubes has a height in the range from 2.5 to 7.5 nanometers.

13. The method for making a magnetic storage medium in accordance with claim 7, wherein a distance between adjacent carbon nanotubes is in the range from 2 to 10 nanometers.

14. The method for making a magnetic storage medium in accordance with claim 7, wherein the carbon nanotubes are formed by chemical vapor deposition or plasma enhanced chemical vapor deposition.

15. The method for making a magnetic storage medium in accordance with claim 8, wherein the magnetic material CoCrXYZ has 60˜90 mol % of Co, 5˜20 mol % of Cr, 2˜5 mol % of X, 5˜15 mol % of Y and 1˜15 mol % of Z.

16. A method for making a memory storage medium, comprising:
providing a base of carbon nanotubes arranged in a regular array; and
disposing material, with rod-like bodies and capability of saving medium memory, into the carbon nanotubes.

17. The method of claim 16, wherein said material is magnetic.
